(19) United States
(12) Patent Application Publication
(10) Pub. No.: US 2007/0109542 A1
(43) Pub. Date: May 17, 2007

(54) Optical resonance analysis unit

(76) Inventors: David H. Tracy, Norwalk, CT (US); Jennifer M. Brockman, Arlington, MA (US); Keith S. Ferrara, Stratford, CT (US); Martin Shenker, New York, NY (US); Robert Kersten, Granby, CT (US); Steven E. Cohen, South Windsor, CT (US); Gary Bodley, Colchester, CT (US); Patrick Tuxbury, Wallingford, CT (US); Paul Hetherington, Brewster, NY (US); Enrico Picozza, Hopkinton, MA (US)

Correspondence Address: Leon R Yankwich;Yankwich & Associates, 201 Broadway, Cambridge, MA, 02139, US

(21) Appl. No.: 10/566,303

(22) PCT Filed: Aug. 2, 2004
(86) PCT No.: PCT/US04/24789

§ 371 Date: Jan. 27, 2006

Related U.S. Application Data
(60) Provisional application No. 60/492,062, filed on Aug. 1, 2003.
(60) Provisional application No. 60/492,061, filed on Aug. 1, 2003.

(51) Int. Cl. G01N 21/55

(52) U.S. Cl. 356/445

(57) ABSTRACT

An optical analysis unit especially suitable for performing grating coupled surface plasmon resonance (SPR) imaging features a pivoting light source capable of scanning through a range of angles of incident light projected onto a stationary target sensor, such as an SPR sensor. The reflected image from the illuminated sensor is detected, e.g., by a CCD camera and the image and angular scan data are processed, for example by a fitting algorithm, to provide real time analysis of reactions taking place on the surface of the sensor.

### CROSS-REFERENCE TO RELATED APPLICATIONS

This application claims priority to U.S. Provisional Application 60/492,061 and 60/492,062, both filed Aug. 1, 2003, the disclosures of which are incorporated herein by reference.

### FIELD OF THE INVENTION

This invention relates generally to optical resonance analysis systems. Specifically, the invention relates to an improved instrument for conducting grating coupled surface plasmon resonance imaging utilizing illumination and detection systems for the real-time analysis of multiple reactions taking place on the surface of a sensor array.

### BACKGROUND OF THE INVENTION

The basic principle of operation of grating-coupled surface plasmon resonance (GCSPR) takes advantage of surface charge vibrations created when light of a certain wavelength strikes a metal surface. For example, a sensor chip comprised generally of a plastic optical grating coated with a thin (˜80 nm) layer of highly reflective metal such as gold is spotted with an array of specific binding molecules (e.g., antibodies). When the chip is illuminated by light of the appropriate wavelength, polarization, and angle of incidence, a resonance condition is caused when energy from the light couples into the electrons of the metal to excite a surface plasmon. Thus, this resonance condition is a propagating oscillation of free electrons in a metal at the metal/dielectric interface. In this example, the metal is the gold layer and the dielectric is an aqueous solution containing the molecules to be analyzed, which is flowed across the metal surface to contact the immobilized binding molecules. The surface plasmon has an electric field perpendicular to the interface, along which it can propagate. The amplitude of the plasmon electric field is maximal at the interface and decays exponentially perpendicular to it. Penetration into the dielectric depends on the wavelength of the exciting light and typically is in the range of 100-300 nm. The resonance condition (when incident light couples into the surface plasmon) is manifested by a large fall in reflectance of the incident beam.

As molecules from a solution bind to material deposited on the metal surface, the refractive index of the deposited material changes, which then causes a shift in the SPR resonance angle. SPR can be used for detection of molecular binding reactions on the surface of the sensor chip because the SPR resonance condition depends on the index of refraction at the metal/dielectric interface. Thus, molecular binding reactions on the surface of the sensor chip cause a shift in the resonance condition, which may be monitored as a shift in wavelength, angle of incidence, or intensity depending on the implementation approach.

However, current grating coupled SPR methods employing angle scanned array imaging to measure many samples in parallel share certain disadvantages with other angle scanned optical resonance sensor methods, including Kretchmann SPR imaging approaches. See, Kretschmann, Z. Phyzik, 241:313-24 (1971). Many of the problems associated with angle scanned array SPR are related to system optics and the fact that SPR array imaging requires a relatively high numerical aperture imaging system to accommodate the range of illumination angles involved in an SPR scan, but for each individual exposure or image frame during an angle scan the light is highly concentrated into a small portion of the full aperture pupil.

Conventional lens designs used for SPR detection analysis exhibit a scan angle-dependent image defect known as “walking” or “ROI shift”, in which the image of a region of interest (ROI) on the sensor chip moves across the detector surface as the illumination angle (incident angle) is scanned. Waking is especially pronounced in the peripheral regions of the field. This effect is due to a combination of high order aberrations which depend both on aperture angle and field radius, and is exacerbated when the object plane is tilted. Such aberrations are common in conventional high numerical aperture imaging systems but are generally tolerated, merely causing loss of contrast or resolution when all aperture angles are present simultaneously. However, in array SPR they pose a serious problem since highly accurate reflectance measurements must be made at carefully defined locations on the sensor chip surface as a function of illumination angle. Only a small portion of the lens aperture pupil is used for any one exposure, but the portion employed moves across the aperture during the angle scan, thereby changing the image position on the detector.

The ROI shift effect can be compensated for, to a degree, in software by moving the detector pixels comprising the ROI as a function of scan angle so as to track the motion of the ROI image. See, Zizlsperger and Knoll, Progr. Colloid Polym. Sci., 109: 244-253 (1998)). However, such post-event data processing compensation for the walking effect is a less preferable solution to the generation of more accurate data in the first place.

Another problem associated with the aforementioned severe instantaneous underfilling of the aperture pupil in current SPR array instruments is the phenomenon of “hot spots” or image flare caused by multiple reflections between the various optical surfaces, particularly between lens element surfaces. Although such multiple reflections cause stray light and some loss of contrast in all multi-element refractive imaging systems, even with the use of antireflective coatings, the effect is generally benign. In angle scanned SPR imaging systems, however, the high concentration of light intensity in a small portion of the aperture pupil often results in the stray light being concentrated in relatively small regions of the image field on the detector surface. These concentrated zones are the “hot spots”. Moreover, the hot spots generally move across the image as the illumination angle is scanned. Although their intensity is a very small fraction of the direct intensity on the detector, the hot spots can significantly modulate the apparent reflectance dips associated with affected ROIs. The affected ROIs will have a widely varying SPR resonance angle compared to the unaffected ROIs, which therefore results in increased background noise in the system.

Although others in the literature have used imaging, it has suffered from scan dependent artifacts, or else scanning has been avoided altogether. For example, Zizlsperger and Knoll, infra., have described a system in which angle scanning results in huge “walk”, which was elaborately handled via software tracking of ROIs. Guedon et al. have described a system which would exhibit poor imaging and huge walk as well but compensates via using a fixed angle and relatively few and large ROIs. See, Guedon et al., Anal. Chem., 72: 6003-6009 (2000) and Lyon et al., Review of Scientific Instruments, 70(4): 2076-2081 (1999). Another approach is the double grating normal incidence imaging of the Knoll patent, U.S. Pat. No. 5,442,448, although this system introduces additional complexities. However, fixed angle and wavelength systems have very limited dynamic range and are susceptible to source intensity fluctuations. For example, none of the aforementioned techniques would be able to get a good enough image to read a logo or other small identification or indexing feature, or even a small ROI, on the sensor surface, even with the software compensation. In systems such as contemplated herein requiring detection of resonance angle for an array of target and reference ROIs, which entails comparison of target ROIs exhibiting immobilized reactants against reference ROIs exhibiting the bare metal sensor surface, a large dynamic range is needed—that is, resonance angles that vary widely need to be detectable. Such applications require subtraction of resonance angle of target ROIs and reference ROIs to compensate for system fluctuations that affect both types of ROI, e.g., temperature, pressure, and bulk refractive index changes.

Steiner et al., in Journal of Molecular Structure, 509: 265-273 (1999), discuss improvement of SPR image quality by tilting the detector CCD chip. While accomplishing the objective of correcting for the simple defocus found for a static non-normal angle of incidence SPR imaging system, it does not fully address the problem of image “walk” when collecting images over the wide range of incident angles required for an array sensor having significant dynamic range. Because the Steiner et al. instrument did not continually angle scan, but only collected images at a single, fixed angle, the “residual walk” described in the present application remained unnoticed.

The present invention is the first to describe and correct for this unexpected residual walk effect, previously unknown in the art.

Surprisingly, the present invention has solved these optical problems via a complete set of “angle scan compensated imaging” techniques, which include appropriate tilting of the detector (CCD) chip, special optimizations of the imaging optics to minimize ROI shift, a corrector plate, and special alignment techniques.

Accordingly, the present invention is directed to an improved optical resonance analysis instrument suitable for performing grating coupled SPR analysis and useful for simultaneously monitoring an array having hundreds of separate reaction areas (i.e., target ROIs) on the surface of a sensor. As described below, the present invention provides a number of advantages over current instrumentation which (usually) relies on the above-mentioned Kretschmann-type SPR analysis and which is limited in the number of usable reaction sites and the accuracy and dynamic range of measurements.

In addition, the present instrument has been designed to solve many of the problems described above that currently exist in the field of grating coupled SPR array analysis and, as such, represents a significant advancement in the field.

### SUMMARY OF THE INVENTION

Accordingly, the present invention is directed to an improved optical resonance analysis imaging instrument for use in grating coupled surface plasmon resonance (GCSPR). In particular, the present invention combines a number of features which, in addition to providing real-time simultaneous analysis of up to thousands of molecular binding interactions on the surface of a sensor, also provides improvements in controlling reaction parameters involving system fluidics, temperature control, sensor scanning, as well as data collection and analysis from the scanned sensor. In addition, the present instrument is designed to optimize angle scan range, angle accuracy, image fidelity, and eliminate resonance artifacts. In addition, the present invention describes novel methods for monitoring reactions occurring on the surface of a sensor utilizing the novel instrument described herein.

Included with the novel features of the present, invention is a novel relay lens design that significantly improves the imagery over the entire field while minimizing image motion (“walk” or “ROI shift”) as the beam angle is scanned, which in turn greatly improves the overall resolution of the scanned sensor surface. To accomplish this surprising improvement in imagery, it is critical that the instrument described herein be capable of achieving unusually precise alignment of the entire integrated optical system, and in particular the alignment between the sensor, light source, and detector (e.g., CCD camera) as is described in further detail below.

More specifically, according to the present invention, critical aspects of the interaction between system components include the focus position of the camera lens, the distance between the detector and the sensor surface, as well as the tilt angles of the detector in relation to the sensor surface. The mechanical features of the instrument described herein are interconnected in such a manner as to cooperatively perform the necessary adjustments required to optimize performance of the optical unit. These mechanical adjustments are preferably carried out with the assistance of image analysis software which is specially designed to analyze critical data and assist with the rapid adjustment of various parameters to quickly optimize the instrument calibration for improving image quality and reducing optical image aberrations.

In one aspect, the present invention is directed to a fully enclosed and integrated optical grating coupled surface plasmon resonance analysis unit. The unit includes a support frame with a target area designed to accept a sensor. In one embodiment, the sensor may be a grating coupled surface plasmon resonance chip suitable as a substrate upon which thousands of molecular binding reaction sites may be precisely arranged for simultaneous optical analysis. The unit may be designed so the sensor may be inserted into the target area either mechanically or manually.

The present invention includes a light source for directing illumination onto the sensor, which illumination is then reflected from the surface of the sensor to a novel detector assembly described in more detail below. In embodiments of the present invention, the sensor will remain stationary and the light source is mounted on the instrument frame so as to allow the beam of light emanating from the light source and directed onto the reflective sensor to move through a plurality of angles with respect to the sensor. For example, in preferred embodiments the light source is pivotally affixed to the frame such that the beam of light emanating from the light source can impinge on the sensor at a plurality of angles. In a particularly preferred embodiment, the light source is mounted on the frame of the enclosed unit in such a manner that the light source is movable in an arcuate pathway, so that it can illuminate the target area from a multiplicity of different angles in a bi-directional pattern, i.e., positive and negative direction. The sensor surface is positioned at the optical vertex of the pivoting light source in order to minimize intensity fluctuations moving across the sensor which can lead to increase in signal noise.

In one embodiment, the light source is comprised of a light emitting diode (LED) assembly for generating the illumination that is directed to the sensor. By way of example only, the LED assembly may be comprised of a single 875 nm LED mounted on a PC board and may include a separate aperture element for blocking out unwanted light, however, there are many variations on this design including a wide range of suitable LED wavelengths. The LED lens assembly of the present invention is designed to as much as possible mimic a point light source, thereby minimizing any stray light emanating from the LED die itself, which can lead to a less collimated source beam and cause multiple source points, both of which result in increased resonance width and, in turn, increased SPR angle noise. The front of the LED assembly may be advantageously modified from a dome shape by lapping it to an optically flat surface, to direct all light rays out in a predictable path through the aperture and into a collimating lens.

In addition, the light source of the present invention also includes a source optics assembly for controlling and optimizing the characteristics of the light impinging on the sensor from the light source. In one embodiment, the source optics assembly is enclosed in a lens tube and further includes a lens suitable for collimating the illumination emanating from the light source, an interference filter for blocking unwanted wavelengths and a means for generating p-polarized light. In one embodiment, the filter width is 4 nm, which was chosen to prevent excessive broadening of the SPR resonance profiles, and which also prevents coherence noise, (“speckle”). In another embodiment, a second polarizing filter can be added (or, alternatively, the existing polarizer can be rotated 90 degrees) to generate S-polarized light, so the effects of variations in intensity can be cancelled out. The lens tube also provides a means for focusing the collimating lens.

In another embodiment, the light source may be pivotally attached directly to the instrument frame or alternatively may be in contact with the frame via a pivot arm. The pivot arm may include a support frame which is pivotally attached to the unit frame. In this embodiment, the pivot arm includes a means for securing the light source and a means for connecting the light source to a driving means for moving the pivot arm and light source such as, for example, a motor.

In a preferred embodiment, the light source is in contact with and repositioned by a stepper motor which may be attached directly to the light source or secured to the frame of the unit. In one embodiment, the motor is secured to the unit frame and in contact with the light source via a linear arm to allow it to translate from a linear direction to angular which is attached at one end to the light source and is engaged with the motor such that the action of the motor drives the arm back and forth, in turn causing the light source beam to pivot approximately through the center of the sensor surface about an axis that is parallel to the grooves of the sensor grating. In one embodiment, the arm is threaded and is moved by rotational action of the motor.

In an alternative embodiment, the instrument described herein may include a linearly scanned LED, wherein the light source lens system may be rigidly fixed to the frame and the LED may be mounted to a moving linear slide driven by a motor. The motion of the LED changes the angle at which the collimated light impinges on the sensor. This embodiment has several advantages including a smaller motor required to reposition the light source beam through the desired range of angles, a shorter distance the LED is required to traverse to deliver the same dynamic range, reduced vibration from lower mass, and lower costs for equivalent scan precision.

In another embodiment utilizing a rotating mirror, the source optics and LED may be fixed on the frame and impinge light onto a pivoting mirror. In this particular embodiment, the instrument will include a means for precisely controlling the incident angle of the mirror. The advantages of this particular embodiment are as described above for the linear LED.

In yet another embodiment, a linear array of source optics may be mounted to the frame and directed toward the target area containing the sensor. The geometric positioning of the source optics, i.e., distance from the sensor and pitch between them create a minimum required angle of the incident light between any two adjacent optics so that there are a sufficient number of intensity data points to establish and fit an SPR curve. The source optics can be sequentially illuminated very rapidly to increase the data collection rate. Key advantages of this system are that it is solid state, geometrically stable, and results in increased data rates.

Additional variations include keeping all the source optics illuminated and passing a moving aperture over them at a precisely controlled rate, so that the aperture limits which rays impinge on the sensor as well as the exposure time.

In one embodiment of the present invention, collimated light generated by the light source impinges onto the surface of the sensor at a range of angles and is reflected from the surface to a detector assembly positioned to receive the reflected light from the sensor. In one embodiment, the detector is attached to the frame and oriented to receive the light reflected from the sensor surface. The reflected light changes intensity as a function of the reactions taking place at each ROI on the surface of the sensor as it scans through the range of angles. The signal output for each image frame is converted into a measurement of two values for each ROI: (1) the intensity of the reflected light received by the detector, summed over the detector pixels comprising the ROI, and (2) the corresponding angle of incidence at which the reflected intensity was measured as recorded by an angle encoder. As each angle scan is completed, the information gathered is then transferred to a resonance quantification algorithm, preferably an Empirical Profile Fit (EPF) algorithm, where the data described above for each ROI are fitted to a calibrated SPR profile and the position of the curve minimum is determined for each ROI. These resonance positions are then tracked over time, by means of successive angle scans over the course of a run. Real time monitoring of the SPR minima by the novel instrument described herein provides important information on the reactions taking place on the surface of the sensor at each of the up to thousands of individual ROIs. In particular, for biomolecular sensing, the time dependence of the SPR response allows for the calculation of kinetic constants, kₒₙ and k_{off}, which describe the binding and dissociation interactions taking place at each of the ROIs on the surface of the sensor.

In a preferred embodiment, the novel detector described herein is comprised of a novel lens assembly for receiving light reflected from the surface of the sensor, a charge-coupled device (CCD) camera, and a multicomponent gimbal mount assembly for adjusting the camera assembly in multiple planes. The novel detector assembly described herein will also preferably include a corrector plate in the lens assembly to help reduce image aberrations contributing to ROI image shift (the “walking” effect), and additionally may include a passive cold finger to prevent vapor deposition on the detector optics, which can cause intensity fluctuations.

In a particularly preferred embodiment, the lens assembly is specially designed for use in the novel optical resonance analysis unit described herein. Specifically, the lens assembly has been specially designed to maintain image stability on the CCD camera as the light source scans over a range of illumination angles. Sensor analysis using conventional lens systems results in “walking” or the appearance that target spots (target ROIs) have moved or migrated in relation to their actual site on the sensor surface as the angle scan proceeds. This leads to at least partially measuring reference ROIs (bare metal) rather than only target ROIs, in turn leading directly to an increase in measurement noise. The lens assembly of the present invention is designed to reduce this ROI shift effect and the resulting SPR noise, thereby allowing for a more accurate reading and analysis of the reactions taking place on the surface of the sensor. The optical system of the present invention is further adapted to provide accurate imaging over the entire sensor surface under conditions of off-axis operation, or object plane tilt.

The novel lens system described herein includes a sensor imaging lens having a monochromatic double telecentric design, with a magnification advantageously selected to project the image of the entire SPR sensor area onto the image-receiving optically sensitive area of the detector (e.g., the CCD chip area). The present optical system optionally includes a tilted corrector plate designed to be used in conjunction with appropriately tilted object (sensor) and image (CCD detector) planes. The optical design takes full account of the sensor window, aqueous sample layer, and detector camera window. Unlike conventional lens designs, the novel lens assembly of the present invention is specifically designed to minimize image walk at the operating wavelength, over the entire range of illumination scan angles (required for the aforementioned large dynamic range). The present lens assembly includes an objective section which produces an image of the tilted object plane at infinity, followed by an imaging section which takes this virtual image and creates a real, demagnified image on an image plane, also tilted, which plane coincides with the two-dimensional detector surface. Both the optical and imaging sections share a common intermediate aperture plane which is located in the void between the sections. A slot-shaped aperture stop is interposed between the objective and imaging sections in this plane. The novel aspects of the lens assembly are further described in detail below.

The optical analysis unit of the present invention preferably also includes a rotary encoder for precisely determining the incident angle of the light source described above, i.e., the angle at which the illumination is impinging on the surface of the sensor. The rotary encoder is preferably secured within the unit and is in contact with the light source in such a manner as to determine its angle in relation to the sensor surface. This information is then transferred to the resonance quantification algorithm (e.g., an EPF algorithm), where the data are fitted to calibrated SPR curves for the various target spots (ROIs) and the positions of the curve minima are tracked over time. In a preferred embodiment, the rotary encoder is comprised of a pivot shaft, encoder housing, and encoder.

A linear encoder may be used as an alternative to the rotary encoder described above, and this will require a conversion from linear to angular units in order to track the position of the moving source optics as described above. In another alternative embodiment a stepper-type motor mechanism capable of directly determining change in angle with a high degree of accuracy may be used in place of the rotary encoder.

Additional embodiments of the optical analysis unit of the present invention also include a complex fluidics system for transporting various fluid reagents and sample solutions to and away from the surface of the sensor. In one embodiment of the present invention, prior to experimental runs, the fluidics system of the present unit may be prepared by cleaning and flushing the system as well as purging air bubbles from the system, which bubbles can adversely affect the reaction taking place on the surface of the sensor as well as the ability of the instrument to gather and interpret the reflected optical data accurately. Subsequent to contact with the sensor, the fluidics system is designed to allow the user to direct the fluids to a waste receptacle or, alternatively, the fluids may be redirected back through the system for either recontact with the sensor or retrieval from the unit.

In one preferred embodiment of the present invention, the fluidics system contains independent sample and buffer paths to allow users the ability to prepare both fluid paths simultaneously as well as to prepare one particular fluid line while an SPR baseline (e.g., against a buffer solution) is simultaneously being established. Accordingly, samples can be introduced to the system just prior to contact with the sensor surface, thereby maintaining the integrity of sensitive samples, especially samples that tend to degrade rapidly when removed from optimal storage conditions of, e.g., low temperature, anaerobic storage, etc.

In addition, in a preferred fluidics system of the present invention, both sample and buffer paths lead to a 4-way adjustable valve which is positioned in close proximity to the sensor. The valve serves to minimize sample/buffer mixing, which is critical to accurate determination of kinetic values.

Additional features of the preferred fluidics system will include a sample inject station (SIS) which serves as a juncture for samples entering the system and waste leaving the system. According to this feature, sample needles are mechanically lowered into the solution and the sample is then aspirated up by a pump and injected into the sensor. The needles can be operated mechanically or manually. The SIS gives a user the option to discharge samples to waste, collect the sample, or to recirculate the sample over the sensor area. The ability to recirculate the sample(s) as described herein is particularly advantageous where the user can acquire only small amounts of a particular sample or samples. The flexibility of the SIS described herein may optionally allow users to connect to an automatic sampler (e.g., a sample bank or carousel) for injection of a wider variety of samples into the system automatically.

Another advantage of the most preferred fluidics system described herein is the capability for “on the fly” sample loading which is made possible by two separate pumps, one driving the buffer solution and one driving the sample, which allows the user to prepare the sample while the buffer is running through the system. In many instances, it is advantageous using the present instrument, to allow buffer solution to run separately through the system for a few minutes or longer in order to establish a baseline. In addition, in cases where sample loading is time-dependent, for example where the time between sample preparation, mixing, etc., and loading is required to be short due to sensitive samples that may degrade over time and/or with changes in temperature, independent buffer and sample fluidic paths allow samples to be prepared and loaded just minutes or even seconds before injection and introduction onto the sensor. Sample recirculation as described above is also advantageous for samples with particularly slow on-rates (i.e., low association constants) as it allows the samples to keep (re)cycling through the system for sufficient lengths of time to observe sufficient response to calculate accurate association constants k_{ON}.

In addition, if a reaction proceeds slowly, then recirculation is particularly advantageous in that small amounts of sample may be continually recontacted with the sensor surface, whereas if this option were not available, the user would have to acquire much larger amounts of a sample, which may be difficult or prohibitively costly, if not impossible. This “endless supply” of re-circulating sample thus provides sufficient flexibility in both the contact time and flow rate to allow for the monitoring of very slow or mass transport-limited reactions.

The use of a 4-way valve is particularly advantageous in the fluidics system of the present invention because: (1) it maintains the integrity of the concentrations of the buffer and samples as the system is simultaneously running and preparing for sample injection and, (2) the location of the 4-way valve, i.e., immediately adjacent the sensor, minimizes any mixing of the buffer/sample interface.

The fluidics system of the present invention also includes a “bubble blast” high velocity pulsating flow driven by a syringe pump. When putting a new flow cell (containing a new sensor chip) into operation, it is commonly the case that air bubbles remain in the cell gap after filling with buffer. Air bubbles may also inadvertently be introduced during sample switching and other fluid transport operations. These bubbles prevent accurate measurements of the binding reactions on affected ROIs and must be removed, which can be difficult, particularly where the dimensions of the flow cell containing the sensor are reduced, as is common in the field of the present invention. It has been demonstrated that brief applications of very high fluid flow rates, in excess of a Critical Dislodgement Flow rate (CDF), can remove bubbles trapped by inhomogeneities of wetting tension at flow cell surfaces, or by geometrical discontinuities.

It has been determined in the present invention that multiple applications of high flow pulses are usually necessary to eliminate bubbles as they move from one “sticking” site to the next. In order to remove any bubbles from the flow cell, the fluidics system incorporates a positive displacement pump (syringe pump) which is used to apply a “bubble blast”, or series of high flow rate pulses to the sensor cell, e.g., via a low flow impedance fluidic channel. In addition, real-time monitoring for bubbles can pause the fluidics operation and “blast” any bubbles that may accumulate.

In order to maintain the stability of the system, as well as to generate accurate and consistent data on the binding reactions taking place on the surface of the sensor, it is particularly advantageous, according to the present invention, for the user to have the ability to exercise some control over the temperature of the sample and solutions that come in contact with the sensor, to control the ambient temperature surrounding the sensor, as well as the sensor itself, especially the sensor surface where the binding reactions under analysis take place. In addition it is desirable to allow the user to conduct experiments at various temperatures both above and below ambient temperature. To facilitate the above-described temperature control, the unit of the present invention may advantageously include a thermal chamber that encloses the target area where the sensor is located and encloses at least a portion of the above-described fluidics system. In a preferred embodiment, the thermal chamber comprises a proportional integral derivative (PID)-controlled thermal electric device module including a circulating fan, heat sinks, thermal fuse, and sensor. The thermal chamber is preferably lined with insulating foam that maintains thermal stability within the thermal chamber. This insulation protects the sensor area, chemical reactions, and incoming fluids against temperature fluctuations that may be caused by the environment or by operation of the instrument. Also preferably included within the thermal chamber are passive preheaters for maintaining the thermal stability of the incoming fluids. These passive preheaters closely track the temperature of the thermal chamber via circulating air within the closed environment and transferring the heat to or from the fluid by conduction through the walls of the fluidic tubing. Heatsink compound is applied to fill minute gaps between the tubes and the preheater.

### BRIEF DESCRIPTION OF THE DRAWINGS

FIG. 1 shows the optical resonance analysis unit (100) of the present invention with the outer cover attached. The design of the unit provides the user with easy access to the reagent/buffer bottles (50), the sample tubes (40), and the chip door (110) for inserting a sensor (or a flow cell containing a sensor chip) into the unit, without having to remove the outer cover. All other unit functions may be controlled by commands that the user enters into a computer connected to the unit.

FIG. 2 shows the unit of FIG. 1 with the cover removed. The major components of the unit are visible, including the light source assembly (10), including the pivot arm, detection assembly (20), and thermal chamber (30).

FIG. 3 shows one embodiment of the light source assembly (10) attached to a pivot source arm (9) and in relation to the detector assembly (20). The arrows depict direction of the illumination from the light source (11) (down arrow) impinging on the sensor (112) and the illumination reflected off the surface of the sensor (112) and in the direction of the detector assembly (20) (up arrow).

FIG. 4 is a diagram of the pivot source arm (9) with the light source (11, e.g., a LED assembly) and source optics assembly (13)) mounted thereto. Also shown is the linear slide (14) for connecting the pivot arm (9) to a driver motor (12) (not shown), the base plate (18) of the pivot arm (9), roller bearings (17), and light source assembly support (19) for securing the light source (11) to the pivot arm (9).

FIG. 5 is a cross-sectional view of the detector assembly (20) showing the outer casing (22) of the lens assembly (not shown), inner, middle, and outer gimbal mounts (23, 25, and 27, respectively), corrector plate (21), both ends of a passive cold finger (26), detector window (28, e.g., CCD window), detector (24, e.g., CCD camera), and slot aperture (130).

FIG. 6 is a diagram of the various elements of the detector optics located within the lens assembly (encased in outer casing 22 shown in FIG. 5) of the detector. The elements of the lens assembly including the objective section (125), slot aperture (130), imaging section (125), corrector plate (21), and detector window (28), immediately adjacent the optically sensitive element of the detector (113, e.g., the CCD chip). Thus, the lens assembly is interposed between the sensor (112) and the receiver for the image of the sensor reflection, i.e., the detector's sensing element (113). The relative position in the alignment of elements in the lens assembly of the passive coldfinger (26 in FIG. 5), is indicated by numeral 26. X, Y, and Z represent the planes of motion of the detector assembly controlled by the gimbal mounts.

FIG. 7 is a fluidics diagram showing the position of the buffer containers (50) and sample solution containers (40) and the various paths through which each solution can be directed through the unit to the target area (containing the sensor 112) and back to the original sample tube(s) (40), to a separate collection tube (64) or to waste receptacle (63). The sensor is typically enclosed in a flow cell, and the flow cell, which is configured with input and output ports that interface with the unit's fluidics system, is the changeable device that is inserted into the optical analysis unit (100) via the entry door (110 in FIG. 1). FIG. 7 also shows the relative location of the thermal chamber (30), encompassing the preheaters (38), 4-way valve (36) and target area containing the sensor (112).

FIG. 8 is a partial cutaway perspective elevation of a section of an optical analysis unit according to the invention, showing the position of a thermal chamber housing and the position of pre-heaters (38), four-way valve (36) (hidden), top plate assembly (34), insulation panels (32), and a carrier for sensor chips (112).

### DETAILED DESCRIPTION OF PREFERRED EMBODIMENTS

The present invention is directed to an improved optical resonance analysis instrument for use especially in grating coupled surface plasmon resonance (GCSPR) capable of simultaneous measurement of an array of reaction sites. In particular, the present invention combines a number of features which, in addition to enabling real-time analysis of up to thousands of molecular binding interactions, also provides improvements in controlling reaction parameters involving system fluidics, temperature control, sensor scanning, and data collection and analysis from the scanned sensor.

The analysis unit may be fully automated and have all optical scanning operations controlled or implemented automatically by software included with the unit. Essentially, once the buffers, sample, and sensor are loaded into the unit, the user may enter the experimental parameters, e.g., time, temperature, fluid flow rate, etc., into a computer connected to the unit, and the unit can be programmed to perform an entire assay and analysis either immediately or at a set time, and can provide real-time binding data as the assay progresses.

In particular, the present invention is directed to a fully integrated optical grating coupled surface plasmon resonance analysis unit. Particularly preferred embodiments of the present invention will be described below with reference to the drawings. It will be immediately appreciated, however, that the design features described may be altered or modified for particular purposes and that the production of many alternative embodiments of the analysis unit described herein will be possible in view of this disclosure. All such alterations, modifications and additional embodiments are contemplated herein and are intended to fall within the scope of this description and the appended claims. The following description is not intended to limit the scope of the invention in any way.

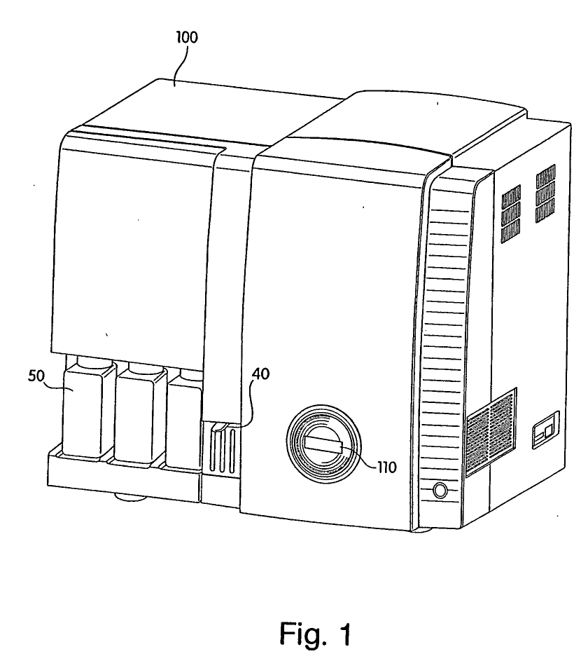

FIG. 1 shows one embodiment of the present invention including the only parts of the unit itself that the user will need to come in contact with, i.e., buffer/reagent bottle(s) (50), sample tube(s) (40), and the sensor (or flow cell) loading door (110). All other functions are automatic and are controlled by computer program with parameters and instructions entered by the user via computer.

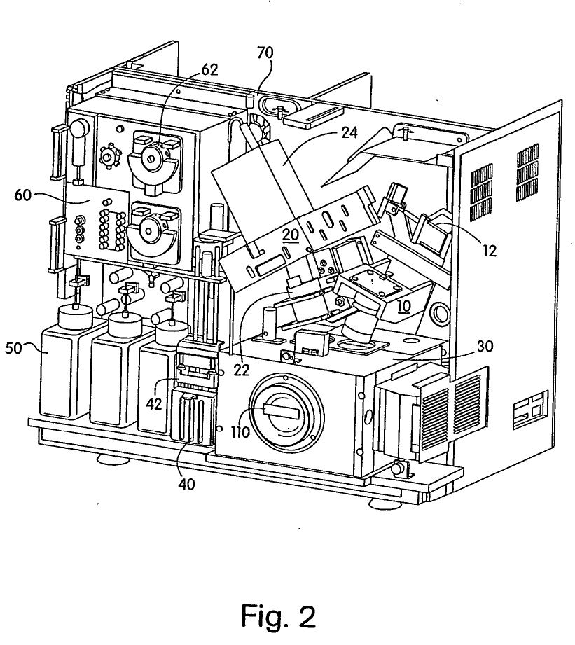

With reference to FIG. 2, the unit includes a support frame (70) enclosed within the unit and includes a target area (not shown) designed to accept a sensor unit (such as a flow cell containing a sensor) via the sensor loading door (110). In one embodiment, the sensor unit may include a grating coupled surface plasmon resonance (GCSPR) chip suitable for conducting and analyzing a variety of molecular binding interactions. A typical flow cell will include a reaction area within which is disposed a sensor chip, an input port adjacent one end of the reaction area through which solutions (buffers, reagent solutions, sample solutions, etc.) may be introduced to flow across the reaction area, and an output port adjacent the opposite end of the reaction area from the input port through which flowing fluid solutions from the reaction area can be directed away from the sensor chip to be collected, ejected to waste, or recirculated through the input port for additional contact with the sensor. The input and output ports are configured so that upon insertion of the flow cell into the analysis unit, the ports interface with the internal fluidics system of the analysis unit, establishing thereby a communication with the sample containers and other fluid reservoirs and receptacles included in the unit.

In addition, FIG. 2 illustrates the relationship of a number of features associated with the present invention. Specifically, FIG. 2 shows a pivoting light source assembly (10), a detector assembly (20), peristaltic pumps (62) of the internal fluidics system, and a thermal chamber assembly (30) which encloses the target area housing the sensor. Once the sensor is loaded into the unit, the light source (10) directs a beam of light onto the sensor (not shown). In a preferred embodiment, the sensor is a grating coupled SPR chip having a reflective gold surface onto which is imprinted or deposited an array of target ROIs that can be scanned by the illumination and reflectance detection assemblies of the unit. The ROIs are typically made up of a concentration of binding moieties (e.g., antibodies, aptamers, single stranded DNA molecules, and the like) capable of interacting with an analyte in a sample solution. The flow cell and fluidics systems are designed to introduce such solutions by flow across the surface of the sensor supporting such ROIs and to simultaneously be in a stationary target position for receiving the illumination from the light source and reflecting a sensor image toward the detector assembly, which will output optical data indicative of binding or other chemical reaction events occurring on the surface of the sensor in real time.

Referring again to FIG. 2, in a particularly preferred embodiment the light source assembly (10) is pivotally attached to the frame (70) of the unit. The pivotal attachment permits the light beam from the light source to be moved through a range of angles with respect to the target area. Alternatively, the light source may be attached to a structure that is itself pivotally attached to the frame. Automatic pivoting of the light source assembly (10) is achieved, for example, by a stepper motor (12) attached to the frame of the unit which is capable of accurately recording the changes in light beam angle that are effected by its action on the light source assembly.

Once the sensor is in place and operation begins, the light source directs a beam of light onto the sensor beginning at a predetermined angle and continuing in an arcuate path or pattern over a range of angles. The light reflected from the surface of the sensor directed toward a stationary detection unit (20) including a lens assembly (22) and a detector (24) such as a CCD camera.

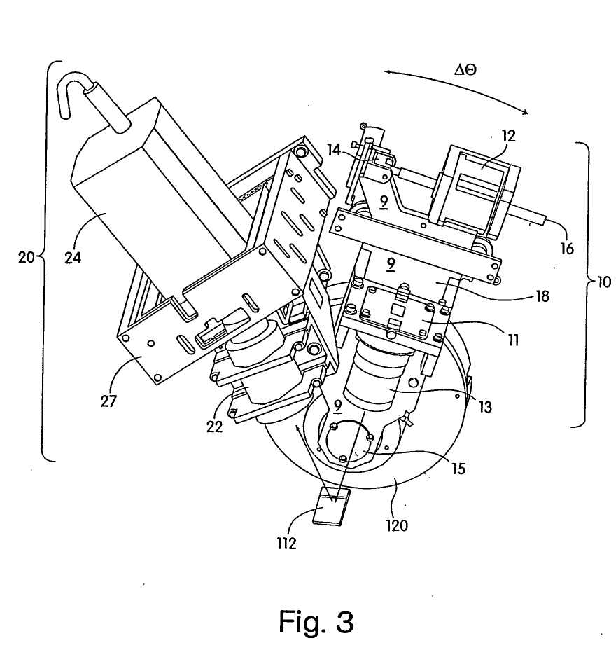

FIG. 3 is a perspective elevation of the basic elements of an analysis unit of the invention. In particular, FIG. 3 shows the light source assembly (10) attached via a pivot arm (9), which is attached in turn to a shaft (15) about which the pivotable arm may (9) may rotate. The shaft (15) will be attached to the unit frame (not shown), so that the entire light source assembly may be moved in an arcuate path. Data on the change in angular position of the light source is reported by some type of angular position encoder, such as a rotary encoder assembly (120), which may be included at the pivot point of attachment of the light source. Encoded angular position data, together with resonance data received by the detector (24), are output to a computer which applies a resonance quantification algorithm and reports on phenomena occurring on the sensor surface. Preferably, for SPR data, the unit will utilize an EPF algorithm for SPR curve determination as described in copending and commonly assigned U.S. Provisional Appln. No. 60/492,061, filed Aug. 1, 2003.

In the embodiment shown in FIG. 3, the pivotable source arm (9) is driven by a stepper motor (12). The motor may be secured to the frame of the unit and includes a means for engaging the light source or pivotable source arm. In an alternative embodiment, the stepper motor may be attached to the light source or pivotable source arm and be equipped with means to engage the stationary frame. In the embodiment shown in FIG. 3, the stepper motor is secured to the frame of the unit and is in contact with the pivotable source arm (9) and thus the light source assembly (10) via a linear arm (16) attached at one end to the pivotable source arm (9) via a linear slide mechanism (14) and engaged with the stepper motor at its opposite end. As the motor is operated, the linear arm is driven forward or backward, thereby positioning the light source at various angles with respect to the sensor (112). The linear arm (16) may be smooth or it may be threaded, in which case the stepper motor will include a means for accepting the threaded arm and will operate the linear arm in a rotary-type motion. Various other methods including servo motor and magnetic drive systems can be employed.

In the embodiment shown in FIG. 3, the stepper motor (12) is capable of accurately recording the change in incident light angle (AO) caused by its operation. Alternatively the pivotally mounted light source assembly may be equipped with a rotary encoder for accurate reporting of the change in angle of the light source. The angle data is then fed, along with reflected intensity data from the detector camera (24), into a resonance quantification algorithm as previously described. In a preferred embodiment, the encoder is attached to the pivot source arm (9) via a pivot shaft (15) and is supported by bearings mounted in the encoder housing (120). To ensure consistent angle readings from one analysis to the next, the rotary encoder includes a built-in indexing mark to precisely determine a reference point at the start of each analysis.

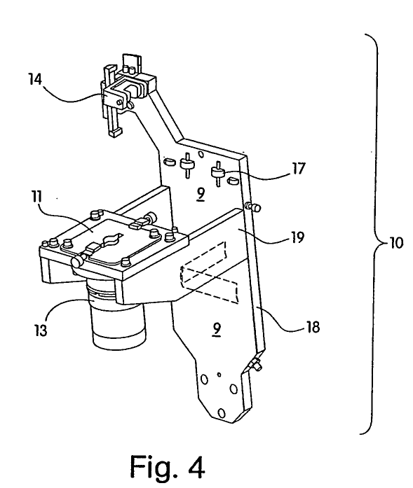

FIG. 4 shows a detailed diagram of one embodiment of the light source assembly (10) including the pivotable source arm (9) of the present invention. The arm includes a base plate (18) for pivotally securing the arm to the unit, a means for securing the light source to the frame (19), a linear slide (14) for connecting the assembly (10) to a stationary motor that will actuate the rotational movement of the light source assembly (10) in operation. Linear roller bearings (17) are shown, which may be included for securing non-vibrational movement of the assembly with respect to the frame.

In operation, the motor (12 in FIG. 3) moves the (illuminating) light source in an arcuate path or pattern over the sensor (112), which continually changes the angle of illumination striking the sensor (112). In this manner, changing the angle of the light source changes the angle of incident light striking the sensor. The sensor is placed at the optical vertex of the light source angular range such that the collimated beam of light stays fixed at one location on the chip surface as the light source is moved through its angular range. This is particularly advantageous in the present invention in that it helps insure that any spatial non-uniformities in the collimated beam intensity remain substantially fixed in relation to regions of interest (ROIs) immobilized on the sensor surface as the angle of incidence is scanned and do not distort the measured resonance profiles, which could lead to spurious apparent angle shifts of the resonances.

In an alternative embodiment, the light source itself may be pivotally attached directly to the frame of the unit. In another embodiment, the pivot point (15 in FIG. 3) of the light source assembly could be the location of the motor or other rotation actuating means.

As seen in FIG. 4, the light source assembly (10) includes a light source such as a LED assembly (11) for generating the illumination that is directed to the sensor. In one embodiment, the LED assembly is comprised of a single 875 nm LED mounted on a PC Board and further includes a separate aperture element (not shown) for blocking out unwanted light. However, a single wavelength light source (or a narrow band wavelength light source) is not critical, and a range of wavelengths are suitable for performing the SPR analyses contemplated herein. An adjustment mechanism for the LED housing is preferably included to align the light source to the off-axis position required to generate a 2 degree lateral offset angle in the collimated source beam. Any plastic housing that encapsulates the LED is preferably ground flat and to a high polish to remove excess plastic and surface imperfections in front of the LED die. This allows accurate collimation and minimizes any light scatter caused by imperfections in the plastic surface. We discovered that the original spherical surface on the plastic encapsulating many commercially available LEDs acts as a low quality lens to direct the LED beam in normal applications, but such a design significantly interferes with the resonance profile sharpness in a SPR system by degrading beam collimation. Optically flattening the plastic housing of the LED significantly and surprisingly decreased SPR noise. Thus, it is most preferred when using a LED light source to procure LEDs with no plastic encapsulation, or to obtain LEDs with flat encapsulation, or to grind the encapsulation of obtained LEDs to exhibit an optically flat covering.

As seen in FIG. 4, the light source also includes a source optics assembly (13) for optimizing the characteristics of the light generated by the LED that is directed to the surface of the sensor. In one embodiment, the source optics assembly is enclosed in a lens tube (13) and further includes a spherical aberration corrected lens for collimating the light to a degree limited only by the dimensions of the emitting region of the LED die. The source optics assembly further typically includes an interference filter for blocking unwanted wavelengths, and a near infrared linear-polarizer (not shown) which is oriented to provide P-polarization incident on the sensor. A conventional cemented doublet type achromat typically provides sufficient spherical aberration correction for this application. The lens tube also provides a means for focusing the collimating lens to optimize collimation of the light generated by the LED.

In a preferred embodiment of the present invention, the light source beam is offset from the centerline of the optics by a short distance (e.g., about 2.3 mm on the scale of prototype instruments of the invention), which results in an angular beam skew of about 2 degrees. This offset is used to reduce any ghost reflections caused by light reflecting from the various optical surfaces in the instrument. In particular, non-sequential ray trace analysis has demonstrated that concentrated spots of stray light in the detector plane (“hot spots” discussed in further detail below) can result from multiple sets of double reflections that occur between various pairs of optical surfaces within the optical assembly, particularly within the imaging lens of the detector assembly. These hot spots move as the SPR angle changes over the course of a scan, resulting in additive distortions to SPR resonance shapes at particular ROIs and hence to inaccuracies in the SPR analysis.

The preferred optical system of the present invention will include one or a combination of three features to minimize the occurrence of hot spots or image flare: (1) all lens surfaces within the imaging lens assembly of the detector assembly (described below) are coated with highly efficient multilayer anti-reflective coatings tuned to the operating wavelength of the light source, i.e, 875 nm in the preferred single wavelength embodiment, (2) as a novel aspect of the present invention, the off-axis lateral beam skew, i.e., the light source offset described above, and (3) combined with the lateral beam skew, an off-axis slot type aperture stop in the imaging lens. These features have been discovered to greatly reduce the hot spots known in prior art systems.

As stated above, the optical analysis unit of the present invention also may include a precision rotary encoder (not shown) for precisely reporting the position of the light source and therefore the angle at which the illumination is impinging on the surface of the sensor. In one embodiment, the rotary encoder is mounted to the frame of the unit and is attached to the light source assembly at its pivotable point of attachment to the frame. In a preferred embodiment, the rotary encoder is comprised of a pivot shaft, encoder housing, and encoder. The rotary encoder reports data concerning the angle of the light source to a computer programmed to interpret the angle position of the transmitting light source corresponding to each camera image. This angle data for each full angle scan and camera image data are input into an appropriate algorithm, for real-time determination of the SPR resonance angles at each ROI on the sensor chip.

As seen in FIG. 2, the optical analysis unit of the present invention includes a detection assembly (20) for receiving light reflected from the surface of the sensor and analyzing the light to measure changes in optical resonance angles at each of up to thousands of reaction sites or ROIs as reactions progress on the surface of an array sensor.

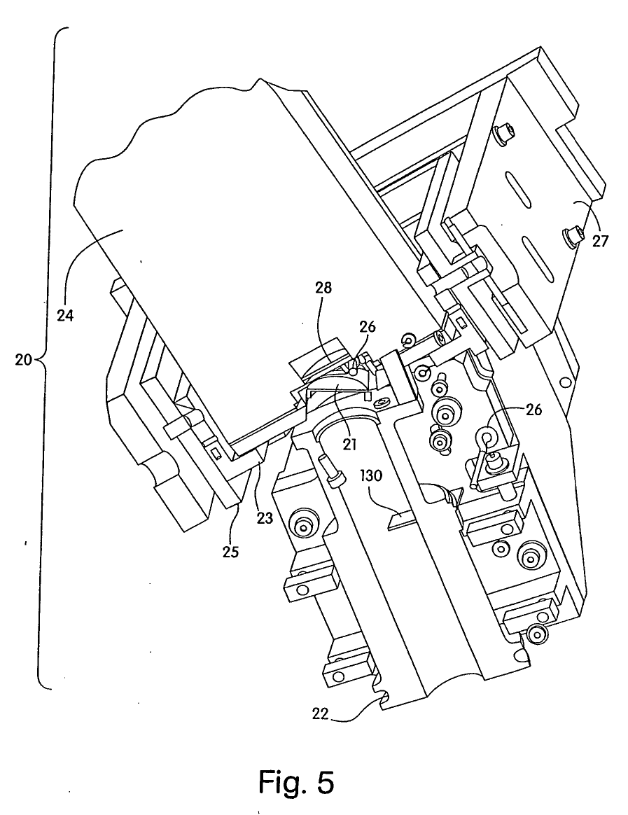

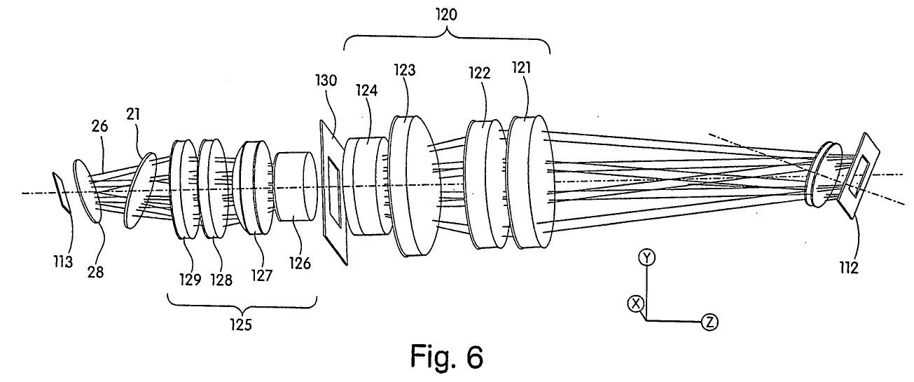

FIG. 5 is a cross-sectional illustration of a detector assembly (20) suitable for the anlaysis unit according to the present invention. In a preferred embodiment, the detector is comprised of an imaging lens assembly (22), including an aperture (130) for receiving illumination reflected from the surface of a sensor (112 in FIGS. 3 and 6), an inner (23), middle (25), and outer (27) gimbal mount assembly for adjusting the detection assembly in multiple degrees of freedom, a detector such as a monochrome charge-coupled device (CCD) camera (24) including an optically sensitive sensing element such as a CCD chip (not shown) mounted in the detector, a corrector plate (21) for reducing the aberrations associated with the walking effect described above, a CCD window (28) for the protection of detector sensing element (e.g., the CCD chip in a CCD camera) and to permit subambient temperature operation of the camera by providing an inert atmosphere for the sensing element, and a passive cold finger (26) for reducing condensation of contaminant vapors from occurring at nucleation sites on the CCD window (28), which may be cooler than its surroundings. Such condensate spots, when present, scatter light and introduce scan angle-dependent signal fluctuations at affected ROIs.

The preferred detector will be a CCD camera selected to (a) have adequate quantum efficiency at the working wavelength, (b) be preferably temperature stabilized for constancy of dark signal offset and response (it may or may not need to be cooled), (c) have sufficiently low dark noise and readout noise, and sufficient analog to digital converter (ADC) resolution so that the signal under normal SPR measurement conditions is substantially photon shot noise limited, (d) have a sufficient number of pixels to clearly resolve the sensor target ROIs, (e) be capable of being read out fast enough to keep up with the angular scan rate, and (f) have as large a pixel well electron capacity as possible to minimize said shot noise. More specifically, the pixel count and the pixel well capacity should be chosen so as to maximize the total combined charge capacity of all the pixels comprising an ROI image. Although the preferred embodiment uses a CCD camera, other solid state array cameras, such as CMOS cameras, may be employed as the detector.

In order to optimize data collection and analysis of the illumination reflected from the surface of the sensor, it is preferred that the detector assembly utilize a specially corrected high numerical aperture double telecentric lens system. “Telecentric” indicates that the lens aperture stop, as seen from the object or image plane, is at infinity. In other words, the acceptance cones from all points on the object plane (or image plane) point the same way, i.e., their axes are parallel. “Double telecentric” means that this is true both for the object side (sensor chip) and image side (detector sensing element). Telecentricity is not essential, but it is highly advantageous in the present invention, especially on the object side, since an undistorted image of all the ROIs on an array must be available over the entire scan angle range. With a telecentric design, the lens aperture maps directly to angles of incidence in the same way everywhere within the object plane, and the full extent of the aperture stop of the lens can be used for accommodating angle scan range at all field points (i.e, over the full surface of the sensor chip.) As stated above, double telecentric, in relation to the present invention, indicates telecentricity also at the detector, and is advantageous in the present invention because it minimizes the extremes of angle of incidence on the detector sensing element (CCD chip) and helps avoid large variations of detector sensitivity between different ROIs at extreme scan angles. In the present invention, double telecentricity is accomplished by making each half of the lens system separately telecentric, so that the intermediate aperture stop, i.e., the slot, appears to be at infinity as seen both from the object space (sensor chip) and from the image space (CCD chip).

This special lens system was designed with a lateral magnification to match the SPR sensor chip active width to the area of the chosen CCD chip, and was specifically optimized to minimize image motion (ROI shift) for the entire sensor field over a scan angle range of almost 10 degrees (object side Numerical Aperture 0.10). This optimization also takes into account the narrow wavelength range employed, as determined by the 4 nm full width at half maximum (FWHM) of the interference filter. The limited spectral bandwidth required eliminates the need for chromatic aberration control, which allows for the use of a single high index glass type for all elements and thus reduces costs. The resulting residual chromatic aberrations are insignificant. This is particularly advantageous because degrees of design freedom are not consumed controlling for chromatic aberrations and distortion. Also because the single glass can have a higher refractive index than the average index of multiple glasses in color corrected systems, fewer lens elements are needed to control the ROI shift aberrations. In fact, it is not clear that both requirements (i.e., ROI shift elimination and broadband color correction) could be achieved at any reasonable cost in a comparable lens design. Certainly commercially available telecentric CCD lenses, which are usually achromatic, do not approach the walk requirements achieved with the present invention.

FIG. 6 presents a diagram of the various elements that comprise the novel lens system within the detection assembly of the present invention. In the embodiment shown in FIG. 6, the lens assembly, which is positioned between the target area sensor (112) and the detector sensing element (113), comprises an objective section (120) made up of refractive elements 121-124, a slot aperture (130), an imaging section (125) made up of refractive elements 126-129, a corrector plate (21), and a detector window (28). The relative position of a passive cold finger element, described above with reference to FIG. 5, is indicated by element 26 in FIG. 6. FIG. 6 also shows the path of light (dotted line) as it impinges on the sensor chip (112) from the light source (not shown), then is reflected off the sensor through the lens optics (120, 125), slot aperture (130), and corrector plate (21), through the detector window (28), and onto the detector sensing element (113).

This special lens assembly design is particularly advantageous because standard ‘off-the-shelf’ lens systems and conventional telecentric lens designs are incapable of maintaining adequate image stability on the CCD camera as the pivot arm scans through the range of angles, which is essential for optimum performance of the optical analysis unit described herein. As outlined above, the camera interrogates regions of interest (ROI) on the sensor, which correspond to the targets to be analyzed. Due to high order aberrations depending on both field size and aperture size in conventional lens systems, the optical images of ROIs fixed on the sensor move or “walk” across the detector surface as the illumination angle is scanned, leading to an increase of measurement noise. This happens especially at off-axis field points and at larger scan angle deviations from the lens axis. In a conventionally illuminated system, where the full aperture stop is illuminated rather than a small point-like zone as in the present case, the aberrations responsible include field curvature, astigmatism, and coma. Importantly, the tilt of the object field (e.g., nominally 21 degrees in the presently preferred configuration) and the resulting image plane tilt according to the Scheimpflug principle, adds to the difficulty of reducing measurement noise. In angle scanned SPR, however, these aberration classifications mentioned above are not directly applicable or useful, and numerical minimization of the image shift as a function of incidence angle is required in the design procedure. Note that aberrations not dependent on both field radius and aperture angle, such as simple distortion, do not usually affect SPR results.

The double telecentric lens assembly described above is specially designed and optimized to solve the walking problem described herein, and includes an objective section and an imaging section, each containing four elements each having high efficiency multilayer anti-reflective coatings, with a specially configured aperture stop interposed between. The track length of the lens assembly in the most preferred embodiment is 272 mm.

The double telecentric design accommodates a high angle scan range (+5 degrees, for 10 degrees total mechanical motion) while minimizing glass element diameters in both the objective and imaging sections. (See FIG. 6.) Keeping the element diameters limited in turn reduces lens cost and weight and facilitates aberration control.

As illustrated in FIG. 6, a slot shaped aperture (130) was chosen instead of a conventional circular aperture stop. Although the lens is sufficiently well corrected to allow use of a full circular aperture of numerical aperture (NA) of 0.10 in the object space (corresponding to 0.18 in the image space), the SPR application described herein does not require use of the entire aperture. Therefore, the aperture is preferably sized to reduce stray light caused by diffuse scattering from the sensor and other surfaces, and to help eliminate residual “hot spots” due to multiple specular reflections. The aperture also allows for an increase in spatial resolution of fiducial markings on the sensor which are designed to (a) enhance usability by helping to determine the exact locations of printable areas when depositing ROI spots on the sensor surface and (b) serve as a reference location to determine the location of the spots themselves when auto-spot-finding algorithms are employed.

At any one sensor illumination angle, the zero order light reflected from the sensor surface occupies a relatively small spot in the aperture plane, so that the instantaneous aperture could in principle be limited to a small circle centered on the current scan angle. This circle would need to be large enough to (1) encompass the finite collimation angle of the light source, and, more importantly, (2) large enough to avoid excessive diffraction blurring of the image resolution, which could prevent faithful imaging of small ROI zones and of auxiliary sensor chip features such as fiducial marks and identification text etched into, or otherwise disposed on, the sensor surface. Because this required circular aperture zone moves linearly across the aperture plane during an angle scan, the preferred composite minimum aperture takes the form of an elongated slot. The length of the slot is determined by the desired angular SPR scan length, while the width of the slot is chosen to minimize diffraction artifacts in the image.

Accordingly, as seen in FIG. 6, the novel aperture stop of the present invention is preferably in the form of a slot with rounded or square ends. This improvement minimizes stray light background and increases apparent SPR resonance depth by eliminating diffusely scattered light at angles corresponding to unneeded portions of the lens aperture. Typical aperture width and length corresponds to approximately 3 degrees and 13 degrees, respectively, in the object space. Preferably, the slot aperture is offset laterally 2 degrees, or approximately 2 mm off the optical axis, to match the light source offset and accommodate lateral beam skew employed to eliminate multiple-reflection hot spots as discussed above. In addition, the hot spots may be partially suppressed by multilayer anti-reflective coatings on the lens elements. The slot aperture may either be fixed in place or removable for convenience in optical alignment procedures.

As indicated in FIG. 6, the mean SPR angle, i.e., the angle at which illumination from the light source strikes the surface of the sensor chip at midscan, is approximately 21 degrees at the surface of the sensor chip. Accordingly, the lens axis is set at an angle of 21 degrees from the normal to the chip surface in order to best accommodate an angle scan range centered on this angle. For best image quality over the entire field, the detector surface is tilted approximately 12 degrees to the lens axis as shown. The precise angle is chosen by ray trace optimization and adjusted using walk minimization criteria, but is approximately given by the well known Scheimpflug condition.

According to the present invention, to further optimize image quality over the entire field, i.e., all ROI's on the sensor chip, residual ROI image shift and other aberrations that result from the field and image plane tilts, namely, the nominal sensor tilt of 21 degrees and the nominal detector element tilt of 12 degrees, are additionally compensated by a flat glass corrector plate (21) approximately 1 mm thick tilted at an angle of approximately 20 degrees. This plate can be omitted with some degradation in image quality and walk performance but is preferably included. In a working embodiment of the present invention, the lateral magnification is 0.57 to match the sensor chip width to the CCD chip dimensions. Because of field tilt, the longitudinal magnification is lower, approximately 0.53.

Also, as seen in FIG. 5 and positionally indicated in FIG. 6, the lens assembly of the present invention will preferably include a passive cold finger (26) to increase the sensitivity of the detector assembly for data analysis. Specifically, air-borne contaminant vapors outgassed by the warmer surfaces in the void between the detector window (28) and the corrector plate (21) are drawn to the coldest surface, which ordinarily is the detector window. Vapor depositing unevenly on the detector window or corrector plate causes intensity fluctuations which lead to increased noise and drift in the SPR signal. To solve this problem, a passive cold finger wire made of high thermal conductivity metal, for example, copper, is connected to a large thermal mass outside the void and is designed to maintain ambient temperature ensuring that the finger is the coolest body in the void and thereby attracts the vapor to it, rather than leaving the vapor to be drawn to, and deposited on, the detector window or corrector plate.

As seen in FIG. 5, the position or orientation of the detector assembly (20) about and along multiple axes may be adjusted through the use of multiple gimbal mounts, i.e., inner gimbal mount (23) secured to the detector assembly, middle gimbal mount (25) secured to the inner gimbal mount, and outer (27) gimbal mount secured to the frame of the unit. Specifically, the gimbal mounts are used to align the image-recording detector sensing element in the detector (24) with the sensor in 6 directions (X, Y, Z, (see FIG. 6) ρ, σ, and φ. This alignment is necessary to make the active area of the detector sensing element (e.g., CCD camera chip) coincide precisely with the demagnified and tilted image of the sensor array formed by the optical system. Orientation along the X or Y axis is adjusted by moving the camera with respect to the inner gimbal mount. Orientation along the Z axis (i.e., the optical axis of the lens assembly) is accomplished by shimming the position of the detector with respect to the position of the sensor. Rotation ρ about the X axis is adjusted by the inner gimbal mount, rotation σ about the Y axis is adjusted by the middle gimbal mount, and rotation φ about the Z axis is adjusted by rotating the detector assembly, e.g., with respect to the plane of the sensor, by adjusting the position of the detector with respect to the inner gimbal. In a most preferred embodiment, the lens assembly is independently adjustable from the detector, permitting fine tuning of the reflected sensor image reaching the detector sensing element.

The gimbal mounts are useful to adjust the orientation of the detector assembly to optimize the match between the sensor reflection and the image received by the detector sensing element. Once this correspondence has been optimized, the detector assembly is made stationary with respect to the position of the target area receiving the sensor. In a scanning operation, therefore, only the light source is capable of movement (i.e., changing the angle of incident light impinging on the sensor), and the sensor and detector assembly remain substantially stationary, or as stationary as possible. Once adjusted, the detector assembly is locked or immobilized, e.g., using immobilization screws; and the design of the target area is such that a flow cell (with incorporated sensor) will be immobilized in the correct position for reflecting incident illumination from the light source and also the correct position to interface with any fluidics system incorporated into the analysis unit. The immobilization of the sensor and the detector with respect to the movable light source avoids the need of coordinating the position of the detector with that of the light source in operation and avoids the need to compensate for fluctuation of the image path with a compensating algorithm in post-data collection data processing.

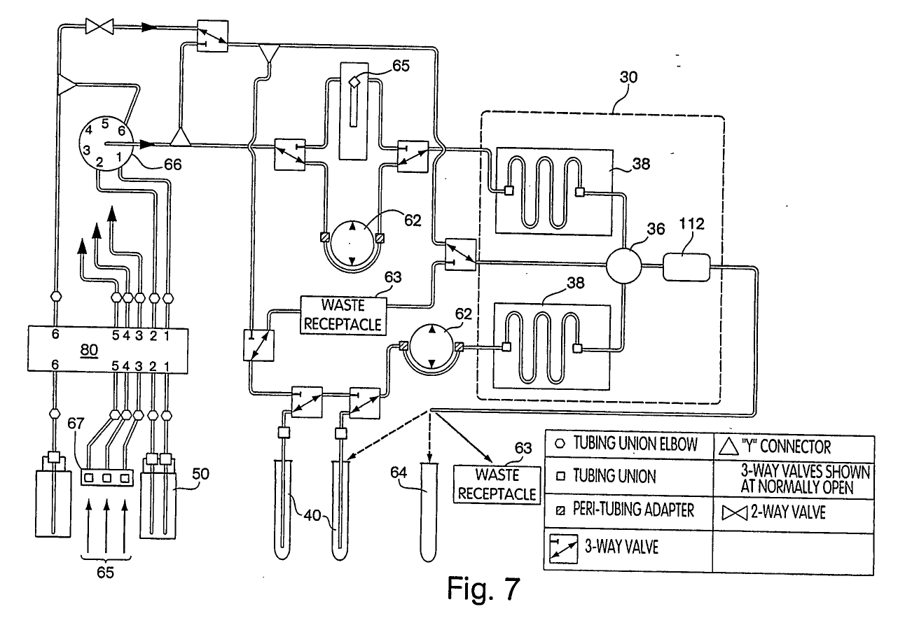

As seen partially in FIG. 2, the instrument of the present invention may also include a complex fluidics system (60) for directing reagents and samples to the surface of the sensor. In a preferred embodiment illustrated by FIG. 7, after the reagents and samples have come in contact with the sensor, the fluidics system is designed to permit the user to direct fluids exiting the flow cell containing the sensor (112) to a waste receptacle (63) or, alternatively, to a collection vessel (64) or back to a sample reservoir (40) for optional recirculation to the sensor area (112) or retrieval from the unit.

As seen in FIG. 7, reagents (e.g., wash solutions) added to the buffer reservoirs (50) which are integral with the fluidics system, are drawn from the reservoirs and into the fluidics system by, for instance, peristaltic pumps (62). However, any known method for drawing or propelling fluids through a conduit system may be used, such as vacuum, forced air, electrokinetics, etc. In preferred features, the reagents are passed through a degassing system (80), as described above, which is integrated into the fluidics system, then directed to the surface of the sensor (112). As seen in also FIGS. 1 and 2, the unit may include a sample area (40) adjacent to the buffer reservoirs (50). As seen in FIG. 2, the sample area (40) is integrated with the fluidics system via sample injection needles (42). The sample area is designed to separately store a number of samples (e.g., analytes or detection antibodies) in separate sample tubes (not shown) enclosed in the sample area. As with the reagents above, the sample is drawn from one of the tubes by the injection needles via, for example, the peristaltic pumps. The sample is directed to the surface of the sensor and, subsequent to contact with the surface, is further directed to either a waste receptacle (63), back through the system for recirculation and recontact with the sensor, back to its original sample tube (40) for retrieval from the unit, or to a special sample recovery tube (64). In addition, as seen in FIG. 7, the fluidics system of the present invention may utilize a multiple channel valve, such as a 6-way valve (66) as illustrated, for directing fluids through specific channels. The unit may also include additional lines (65) for additional buffers by connecting with a bulkhead union (67) included in the unit.

A fluidics system incorporated into the optical analysis unit of the present invention will most preferably also include a “bubble blast” degassing unit (80) capable of providing a high velocity pulsating flow driven by a syringe pump (65). Such a bubble blast system is employed to overcome a problem inherent in a system designed to receive a replaceable flow cell, i.e., so that the sensor (contained in the flow cell) can be constantly changed. When putting a new flow cell into operation, it is commonly the case that air bubbles remain in the cell gap after filling with buffer. Air bubbles may also inadvertently be introduced during sample switching and other fluidic operations. These bubbles prevent measurements on affected ROIs and must be eliminated. They can be difficult to remove, particularly as the cell dimensions are reduced as in the present invention. We have determined that brief applications of very high fluid flow rates, in excess of a Critical Dislodgement Flow rate (CDF), can dislodge bubbles trapped by inhomogeneities of wetting tension at flow cell surfaces, or by geometrical discontinuities.

For example, the CDF required to dislodge a bubble trapped in a planar cell by inhomogeneous surface properties on the sensor surface, such that the wetting tension (τ₂) on the downstream side of the bubble is larger than the wetting tension (τ₁) on the upstream side, is given approximately by
CDF═W h²{τ₂−τ₁}/(6ηL)
where W is the cell width, h the cell gap height, η the viscosity of the fluid, and L the nominal length of the bubble along the flow axis. Although upper limits on the differential wetting tension, Δτ=τ₂−τ₁, can be roughly estimated, the actual values encountered in practice are usually found by experimentation. The analysis clearly shows the geometrical scaling, however, and this scaling is found to be similar for other mechanisms of bubble lodgement. Although the critical flow drops rapidly as the gap height is decreased, the pressure drops associated with the critical flow increase. Also, the inverse dependence on bubble length shows that very small (i.e. short) bubbles can be difficult to remove if wetting tension differences persist over small distances.

It has been determined that multiple applications of high flow pulses are usually necessary to eliminate bubbles as they move from one “sticking” site to the next. In order to remove any bubbles from the flow cell, the fluidics system incorporates a positive displacement pump (syringe pump) which is used to apply a “bubble blast”, or series of high flow rate pulses to the sensor cell, e.g., via a low flow impedance fluidic channel. In addition, real-time monitoring for bubbles can pause the fluidics operation and “blast” any bubbles that may accumulate.

SPR analysis is extremely sensitive to temperature and temperature fluctuations and, as such, this parameter must be as tightly controlled as possible. In order to maintain the stability of the system, as well as generate accurate and consistent data on the binding reactions taking place on the surface of the sensor, it is important for the user to have control over the temperature of the internal environment of the disclosed unit. Therefore, an optional thermal chamber, as seen in FIG. 2, has been designed for incorporation into an optical analysis unit according to this invention, to allow the user to rapidly and precisely regulate the temperature within the system, regulate the temperature of the reagents and samples passing through the fluidics system, and control the temperature of the binding reaction on the surface of the sensor.

In addition, it is desirable to allow the user to conduct experiments at various temperatures both above and below ambient temperature. To accomplish this, as seen in FIG. 2, the thermal chamber encloses the target area where the sensor is located and encloses at least a portion of the above-described fluidics system. In a preferred embodiment, the thermal chamber comprises a proportional integral derivative (PID)-controlled thermal electric device module including a circulating fan, heatsinks, thermal fuse, and sensor.

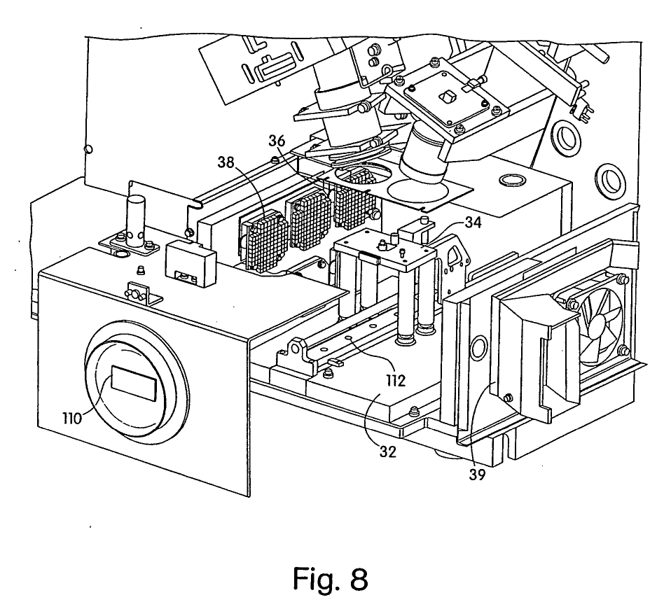

A preferred thermal chamber is illustrated in FIG. 8. The thermal chamber is advantageously lined with insulating foam (32) that maintains thermal stability within the chamber. This insulation protects the sensor area, incoming fluids at the sensor surface, and reactions occurring on the surface of the sensor against temperature fluctuations that may be caused by the environment or by operation of the instrument. Pictured in FIG. 8 are a top plate assembly (34) within the thermal chamber for accurately positioning and securely holding the sensor (flow cell) in place in the target area, and a mechanism for transporting the sensor into the target area. The proximity of the 4-way valve (36 in FIG. 7) to the sensor area is indicated with numeral 36 in this figure. Optical sensors (not shown) may be included for determining the accurate positioning of the sensor (flow cell) against the top plate. Passive preheaters (38) for maintaining the thermal stability of the incoming fluids are also shown. These passive preheaters, made of, for instance, finned copper, closely track the temperature of the thermal chamber via circulating air within the closed environment and transfer the heat to or from the fluid by conduction through the walls of the fluidic tubing embedded into grooves in the heat exchanger blocks. Heatsink compound is applied to fill minute gaps between the tubes and the preheaters.

An alternative to passive heat exchangers is the use of active heating and cooling of fluid flows using additional servo loops. Passive fluidic heat exchangers are preferred, however, on the basis of cost and simplicity, and because they do not introduce temperature cycling or noise due to imperfect feedback control. The difficulty in using passive heat exchangers is that a finite difference in temperature is required for heat to flow to or from the heat exchanger. That difference is proportional to the heat flux demanded, and hence dependent on fluid flow rates, heat capacities, and the fluid temperature increase or decrease desired.

The ultimate goal of the preheater is to bring the fluid as closely as possible to the same temperature as the chamber and therefore to the temperature of the sensor. However, getting the heat to flow in or out of the tubing requires a difference in temperature between the fluid and the air in the chamber. Because any difference in temperature between the fluid entering the sensor's flow cell and the prescribed sensor temperature would change the desired temperature of the sensor, this posed a significant problem. Accurate SPR response is highly temperature dependent. Therefore, if the preheater had sufficient thermal mass it could act as a heat sink or thermal reservoir, but longer runs where the fluid and chamber temperatures were at the extremes would cause eventual heating or cooling of the reservoir, resulting in thermal SPR drift. Moreover, such high thermal mass mitigates against rapid equilibration to adjustments of chamber temperature, which is also required.

The novel solution described herein was to segregate the fluidic heat exchanger for each fluid line into multiple thermally isolated, and serially connected segments. According to this design, the total size and fluidic dead volume for the segmented heat exchanger is dramatically less than that of a single stage designed to achieve the same outlet temperature error. In effect, the first such stage transfers the majority of the total heat flow needed to bring the fluid stream to chamber temperature while reducing the temperature error to a fraction of its original value, but operates with a block temperature far below the chamber temperature and leaves the fluid stream still far from the desired temperature. The next similar stage reduces the error by a similar factor, and so on.

The performance of individual heat exchanger segments in an isothermal air stream can be evaluated as shown schematically below. Heat is transferred from an isothermal air stream into a finned block of high conductivity material, such as aluminum or copper, and then into a fluid stream passing through passages in the block or through tubing in good thermal contact with the block.

Diagram: Thermal analysis of one segment of an air-to-segment-to-water heat exchanger section.

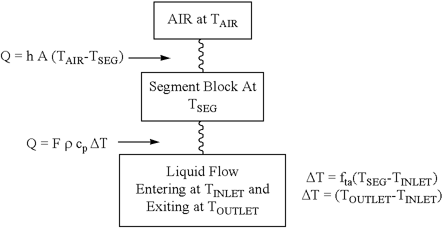

In the foregoing scheme, Q is the heat power being transferred from air at temperature T_{AIR} to the liquid stream within the segment under steady state conditions. The liquid volume flow rate is F, density ρ, and heat capacity c_{P}. The forced air heat transfer coefficient to the finned block is h, the effective area is A, and the temperature accommodation factor of the liquid tube is f_{TA}. Note that f_{TA} is a function of flow rate F. Solving the set of equations shown in the Figure, one obtains for the outlet temperature T_{OUTLET} of a segment:
T_{OUTLET}=T_{INLET}+{f_{TA}hA/(hA+Fρc_{P}f_{TA})}(T_{AIR}−T_{INLET})
where T_{INLET} is the inlet temperature to that particular segment.

The equation above can be rewritten in terms of a “temperature error reduction factor” R, defined as
R≡(T_{AIR}−T_{OUTLET})/(T_{AIR}−T_{INLET}).
The result is
R=1[1/f_{TA}+1/β]⁻¹
where β is a dimensionless measure of a segment's relative air heat transfer efficiency given by
β=hA/(Fρc_{P})
In all cases the fluid temperature accommodation factor f_{TA}(F) is bounded by
0<f_{TA}<1,
and since β>0, R is also subject to the same bound:
0<R<1

Typically segments are designed so that f_{TA}>0.9 and β>6, so that the single stage R value is R<0.22. This means that each independent segment of a multi-stage passive heat exchanger reduces the temperature discrepancy to about 20% or less of its previous value.

At a given fluid flow rate, each heat exchanger segment will act to decrease the difference between the fluid temperature and the chamber temperature by a fixed factor, R, which is always less than unity, and is typically 0.20 or less. Over n multiple thermally isolated segments connected in series, therefore, the fluid temperature error decreases geometrically as R″. By selecting the number of segments appropriately, it is possible to reduce the fluid temperature mismatch with the sensor to an acceptable or even insignificant value, so as to minimize or eliminate any deleterious effects on the SPR signals. We have found that 3 to 4 segments are generally appropriate, providing an optimal balance between temperature equilibration, fluidic dead volume, and flow rate.

As stated above, in order to generate accurate SPR data with the present unit, it is advantageous for the user to have the ability to control the ambient temperature at which the binding reaction on the surface of the sensor takes place. In this respect, it is also advantageous for the user to have the ability to control the temperature of the reagents and sample as they flow through the fluidic system prior to contact with the sensor. In order to accomplish this control over temperature-sensitive elements of the operation, it is preferred to have at least a portion of any fluidics system incorporated into the optical analysis unit enclosed within a thermal chamber such as described above. Preferably, the portion of the fluidics system that is enclosed within the thermal chamber is the section closest to where the binding reaction occurs, i.e., close to the sensor, and includes the sensor itself.

From the foregoing description, many different embodiments of SPR and other optical analysis instruments incorporating innovative features according to this invention will be possible. All such embodiments, including obvious variations of the particularly preferred designs disclosed herein, are intended to be within the scope of this invention, as defined by the claims that follow.

All of the publications and documents cited above are incorporated herein by reference.

What is claimed is:

1. An optical analysis instrument comprising:
(a) a support frame;
(b) a target area attached to said support frame configured to receive and securely hold a flow cell comprising a reflective sensor in a substantially stationary position;
(c) a light source assembly comprising a light source and source optics for focusing light emitted from said light source, which light source assembly is oriented to project a beam of light onto said reflective sensor, and which light source assembly is rotatably attached to said support frame so as to permit alteration of the orientation of said light source with respect to the position of said sensor;
(d) means for altering the orientation of said light source assembly;
(e) means for recording the angular change in the orientation of said light source assembly;
(f) a detector assembly attached to said support frame oriented to receive light reflected from said sensor.

2. The optical analysis instrument of claim 1, wherein said reflective sensor is a grating coupled surface plasmon resonance (SPR) sensor.

3. The optical analysis instrument of claim 1, wherein said means (d) are manual adjustment means.

4. The optical analysis instrument of claim 1, wherein said means (d) are motor means.

5. The optical analysis instrument of claim 1, wherein said means (d) are a stepper-type motor.

6. The optical analysis instrument of claim 1, wherein said means (e) is selected from the group consisting of accurate angular change data from a stepper motor, a rotary encoder, and a linear encoder.

7. The optical analysis instrument of claim 6, wherein said means (e) includes a built-in indexing mark providing a reference point at the start of each optical analysis.

8. The optical analysis instrument of claim 1, wherein said light source is a light emitting diode (LED) or a plurality of LEDs.

9. The optical analysis instrument of claim 8, wherein said light source is a LED emitting a narrow band of wavelengths.

10. The optical analysis instrument of claim 8, wherein said LED or plurality of LEDs is encapsulated in a plastic material and wherein said plastic material is optically flat or made optically flat so as to minimize optical distortion caused by the plastic material.

11. The optical analysis instrument of claim 1, wherein said light source beam is offset from the central axis of said optics to provide a lateral beam skew sufficient to eliminate ghost reflections caused by light reflecting from optical surfaces of the instrument.

12. The optical analysis instrument of claim 1, wherein said light source beam is offset from the central axis of said optics to provide a lateral beam skew of 2 degrees.

13. The optical analysis instrument of claim 1, wherein said detector assembly (f) is mounted on a plurality of gimbals permitting orientation of the detector assembly to be altered with respect to the position of the sensor.

14. The optical analysis instrument of claim 13, wherein said detector assembly (f) comprises a detector comprising a detector sensing element, and a lens assembly for focusing a reflected image of said sensor onto said detector sensing element, which lens assembly is positioned between said detector sensing element and said target area.

15. The optical analysis instrument of claim 14, wherein said lens assembly comprises one or more refractive elements, an aperture stop, a corrector plate, and a detector window.

16. The optical analysis instrument of claim 15, wherein said lens assembly is a double telecentric lens assembly.

17. The optical analysis instrument of claim 15, wherein said detector assembly further comprises a passive cold finger positioned between said detector window and said corrector plate.

18. The optical analysis instrument of claim 15, wherein the orientation of said detector assembly and the refractive elements of said lens assembly are effective to match the dimensions of a reflected image of said sensor to the dimensions of the detector sensing element.

19. The optical analysis instrument of claim 15, wherein said detector and said lens assembly may be independently adjusted with respect to the position of the sensor.

20. The optical analysis instrument of claim 15, wherein said detector is a CCD camera and said sensing element is a CCD chip.

21. The optical analysis instrument of claim 1, further comprising: (g) a fluidics system comprising
(i) one or more solution reservoirs and/or solution input connections,
(ii) supply tubing connecting said one or more reservoirs and/or input connections with said target area,
(iii) removal tubing connecting said target area with one or more elements selected from the group of waste receptacles, solution reservoirs, collection containers, and the target area,
(iv) one or more pumps for impelling fluids through said supply and removal tubing.

22. The optical analysis instrument of claim 21, wherein said fluidics system (g) further includes a bubble blast means for flushing entrapped air bubbles from the fluidics system.

23. The optical analysis instrument of claim 21, wherein a portion of said fluidics system and said target area are enclosed in a thermal chamber.

24. The optical analysis instrument of claim 23, wherein the temperature of fluids being conducted to the target area is controlled using one or more passive heat exchangers.

25. The optical analysis instrument of claim 24, wherein the heat sinks comprise a series of segmented passive heat exchangers.

26. The optical analysis instrument of claim 23, wherein the temperature of fluids being conducted to the target area is controlled using one or more active heating or cooling loops.
